(19) United States
(12) Patent Application Publication
(10) Pub. No.: US 2023/0016262 A1
(43) Pub. Date: Jan. 19, 2023

(54) High Strength Aluminum Alloys

(71) Applicant: Rio Tinto Alcan International Limited, Montreal (CA)

(72) Inventors: Mousa Javidani, Chicoutimi (CA); Alexandre Maltais, Chicoutimi (CA); Clément Boudreault, Falardeau (CA); Martin Fortier, Jonquiere (CA)

(21) Appl. No.: 17/784,688

(22) PCT Filed: Dec. 7, 2020
(86) PCT No.: PCT/CA2020/051679

§ 371 Date: Jun. 13, 2022

Related U.S. Application Data
(60) Provisional application No. 62/948,403, filed on Dec. 16, 2019.

(51) Int. Cl. C22C 21/06; C22F 1/047; C21D 8/06; C21D 8/02

(52) U.S. Cl. CPC C22C 21/06; C22F 1/047; C21D 8/06; C21D 8/0273

(57) ABSTRACT

There is provided a high strength high formable aluminum alloys (Al—Mg—Mn alloy). The aluminum alloy exhibits improved castability by achieving lower required torque at high temperature, while meeting or exceeding the ambient temperature strength and formability requirements for high strength applications. The aluminum alloy comprises in weight percent Mg 1.0-2.0, 0.2-0.95 Mn, 0.05-0.35 Cr with the balance being aluminum and inevitable impurities.

### CROSS-REFERENCE TO RELATED APPLICATION

The present application claims priority from U.S. provisional patent application Ser. No. 62/948,403 filed on Dec. 16, 2019 and herewith incorporated in its entirety.

### TECHNICAL FIELD

The present application relates to high strength aluminum alloys and a process for casting and rolling products comprising same.

### BACKGROUND OF THE ART

Metal armoured electrical cables have been used for many years, in which an electrical conduit is contained within a metal wrap or sheath. This armour wrap is typically formed from steel or aluminum alloys with a thin strip of metal being formed into a spiral with an overlap between each turn or convolution of the strip. When formed into a wrap, the metal strip typically takes on an “S” curve shape in a cross-section view with varying wall thickness.

Classic aluminum alloys are prepared by classic commercial methods and can be conveniently cast and formed by classic methods. For instance, a billet (sometimes referred to as a wire bar) is cast (either semi-continuously or direct chill), then hot rolled to a rod or strip and subsequently cold rolled to final strip dimensions. Alternatively an extrusion billet can be semi-continuously cast then extruded to rod or strip and subsequently cold rolled to final strip dimensions. Frequently, a continuous casting, hot rolling process (for example, Properzi or Secim casting) is used to produce a rod which is subsequently cold rolled to final strip dimensions. After an alloy strip has been formed to final thickness, it is typically heat treated to produce the desired formability.

However, some aluminum products which are first cast, must be subsequently hot rolled and this step can be problematic if the aluminum alloy such as 5052 and 5154 exhibit high flow stress properties at the rolling temperature. The maximum torque of the hot rolling apparatus can be reached, thus inhibiting the capability of producing such harder alloys. It is thus desirable to seek an aluminum alloy which has similar mechanical properties after hot rolling, but with a reduced flow stress the improve the rollability.

### SUMMARY

The present disclosure concern high strength aluminum alloys having improved formability and exhibiting improved rollability by achieving lower required torque at high temperature, while meeting or exceeding the ambient temperature strength and formability requirements for high strength applications. The present disclosure further relates to products comprising the aluminum alloys, and processes for making the products.

In a first aspect, the present disclosure provides an aluminum alloy comprising in weight percent Mg 1.0-2.0, 0.2-0.95 Mn, 0.05-0.35 Cr, 0.00-0.1 Ti, 0.00-0.08 Sr and the balance being aluminum and inevitable impurities. In an embodiment, each of the inevitable impurities is present at a maximum of 0.05 and the total inevitable impurities comprises less than 0.10. In an embodiment, the aluminum alloy further comprises up to 0.1 Ti (e.g., Ti at a concentration of up to 0.1 wt. %). In another embodiment, the aluminum alloy comprises 1.2-1.9 Mg (e.g., Mg at a concentration of 1.2-1.9 wt. %). In yet another embodiment, the aluminum alloy comprises 0.4-0.9 (e.g., Mn at a concentration of 0.4-0.9 wt. %). In still a further embodiment, the aluminum alloy comprises 0.05-0.3 Cr (e.g., Cr at a concentration of 0.05-0.3 wt. %). In a specific embodiment, the aluminum alloy comprises 0.05 Cr. In yet a further embodiment, the aluminum alloy may comprise 0.01-0.2 Si (e.g., Si at a concentration of 0.01-0.2 wt. %). In an additional embodiment, the aluminum alloy comprises up to 0.08 Sr (e.g., Sr at a concentration of up to 0.08 wt. %).

In a second aspect, the present disclosure provides a process for making a rolled aluminum product. First, an aluminum alloy comprising in weight percent Mg 1.0-2.0, 0.2-0.95 Mn, 0.05-0.35 Cr with the balance being aluminum and inevitable impurities is cast to obtain a cast aluminum product. Then, the cast aluminum product is extruded to obtain an extruded aluminum product, and the extruded product is further submitted to a hot deformation step to obtain the rolled aluminum product. In an embodiment, the casting is direct chilled casting, continuous casting or semi-continuous casting. In an embodiment, the aluminum alloy is cast into a billet. In another embodiment, the process further comprises, after casting and before extruding, heat treating the cast aluminum product. In yet another embodiment, the heat treatment of the cast aluminum product is performed for at least 2 h at about 450 to 545° C. to form a heat treated billet. In still another embodiment, the heat treated billet is extruded into a rod. In a further embodiment, the hot deformation step comprises hot rolling the extruded rod to obtain the rolled aluminum product. In yet a further embodiment, the rolled aluminum product is a strip. In still a further embodiment, the process further comprises after the hot deformation step, annealing the rolled aluminum product. In a further embodiment, the rolled aluminum product is an annealed strip. In another embodiment, the process further comprises working the annealed aluminum strip to obtain a conduit of an armoured cable wrap. In an additional embodiment, the rolled aluminum is for making an automotive body, a trailer panel, a hollow electrical conduit or building and construction products.

In a third aspect, the present disclosure provides an aluminum product comprising the aluminum alloy described herein, obtained or obtainable by the process described herein. In an embodiment, the aluminum product is an armoured cable wrap. In another embodiment, the aluminum product is capable of resisting to a pull test UL 4 Ed. 15 standard for armored cable with a pull weight of at least 136 kg (300 pounds).

Many further features and combinations thereof concerning the present improvements will appear to those skilled in the art following a reading of the instant disclosure.

### DESCRIPTION OF THE DRAWINGS

FIG. 1 is a schematic of an embodiment of the process to obtain a cold-roll strip.

FIG. 2A shows the ultimate tensile strength, in MPa of different yield of different chemistries of cold-roll strip (diagonal hatch bars) or annealed (dotted bars) aluminum products.

FIG. 2B shows the yield of different chemistries of cold-roll strip (diagonal hatch bars) or annealed (dotted bars) aluminum products.

FIG. 3 is a graph showing the elongation (E %) of different cold-roll strip (diagonal hatch bars) or annealed (dotted bars) aluminum products. Results of the elongation are shown in function of the chemistry (concentration of main elemental addition) of the alloy used (X axis).

FIG. 4 is a photograph showing embodiments of the products at various steps of the fabrication process of the armoured cable wrap.

FIG. 5 is a schematic showing an embodiment of various processing steps.

FIG. 6 is a graph showing the strength (ultimate tensile strength or UTS (diagonal hatch bars) and yield strength (lozenge bars), in MPa, left axis), and elongation percentage (dotted bars), right axis) of aluminum products in the extruded rod form. Results of the strength and the elongation are shown in function of the chemistry (concentration of main elemental addition) of the alloy used (X axis).

FIG. 7 is a graph showing the strength (ultimate tensile strength or UTS (diagonal hatch bars), in MPa, left axis) and elongation (dotted bars, % right axis) of aluminum products in the rolled strip form. Results of the strength and the elongation are shown in function of the chemistry (concentration of main elemental addition) of the alloy used (X axis).

FIG. 8 is a graph showing the strength (ultimate tensile strength or UTS (diagonal hatch bars), in MPa, left axis) and elongation (dotted bars, %, right axis) of aluminum products in the heat treated strip form. Results of the strength and the elongation are shown in function of the chemistry (concentration of main elemental addition) of the alloy used (X axis).

FIG. 9 is a representative photograph of the failed 4XXX and 6XXX series aluminum armoured cable wrap studied in this disclosure.

FIG. 10 is a representative photograph of a failed conduit made from a 8XXX series Al alloy and compared with a successfully formed 5XXX series Al alloy armoured cable wrap.

### DETAILED DESCRIPTION

The present disclosure concerns high strength high formable aluminum alloys (Al—Mg—Mn alloy) as well as products comprising same, and processes for making such products. The aluminum alloys of the present disclosure exhibit improved castability by achieving lower required torque at high temperature, while meeting or exceeding the ambient temperature strength and formability requirements for high strength applications. The alloys of the present disclosure are especially useful in making products that can be used in an armoured cable wrap, an automotive body, a trailer panel, a hollow electrical conduit, and a building or construction product.

In a first aspect, there is provided an aluminum alloy comprising in weight percent, Mg about 1.0 to about 2.0; Mn about 0.2 to about 0.95; Cr about 0.05 to about 0.35, Si about 0.01 to about 0.2; optionally a grain refiner, and Sr as the modifier and the balance being aluminum and inevitable impurities. The aluminum alloys of the present disclosure have less Mg content than traditional high strength (Al—Mg—Mn) alloys, and in some embodiments, can achieve at least 20% lower required torque than 5052 and 5154 alloys at high temperature (when manufacturing the alloy into a product), while meeting or exceeding the required ambient temperature strength and formability requirements. As it is known in the art, the torque values of two alloys can be compared by measuring the power consumption of the motor driving the hot rolling stands. Alternatively, the torque value can be estimated with a high temperature tensile on compression test.

The aluminum alloy of the present disclosure has Mg content between 1.0 to 2.0 wt. %. Magnesium contributes to solid solution strengthening. Mg can be present in the aluminum alloy of the present disclosure in weight percent from about 1.0 to about 2.0, from about 1.0 to about 1.9, from about 1.0 to about 1.8, from about 1.0 to about 1.7, from about 1.0 to about 1.6, from about 1.0 to about 1.5, from about 1.0 to about 1.4, from about 1.0 to about 1.3, from about 1.0 to about 1.2, from about 1.0 to about 1.1, from about 1.1 to about 1.9, from about 1.2 to about 1.9, from about 1.2 to about 1.8, from about 1.3 to about 1.7, from about 1.4 to about 1.6, from about 1.1 to about 2.0, from about 1.2 to about 2.0, from about 1.3 to about 2.0, from about 1.4 to about 2.0, from about 1.5 to about 2.0, from about 1.6 to about 2.0, from about 1.7 to about 2.0, from about 1.8 to about 2.0, from about 1.9 to about 2.0, from about 1.5 to about 1.6, from about 1.3 to about 1.6 or from about 1.5 to about 1.7. In an embodiment, Mg can be present in the aluminum alloy at a weight percent between about 1.4 and 1.7, for example at 1.5.

The aluminum alloy of the present disclosure comprises Mn between 0.2 to 0.95 wt. %. Manganese can improve the strength of the Al alloys by dispersoid strengthening and solid-solution hardening. Manganese can be present in the aluminum alloy of the present disclosure in weight percent from about 0.2 to about 0.95, from about 0.2 to about 0.9, from about 0.2 to about 0.8, from about 0.2 to about 0.7, from about 0.2 to about 0.6, from about 0.2 to about 0.5, from about 0.2 to about 0.4, from about 0.2 to about 0.3, from about 0.3 to about 0.95, from about 0.4 to about 0.95, from about 0.4 to about 0.9, from about 0.5 to about 0.95, from about 0.6 to about 0.95, from about 0.7 to about 0.95, from about 0.8 to about 0.95, from about 0.3 to about 0.9, from about 0.4 to about 0.8 or from about 0.5 to about 0.7. In an embodiment, Mn can be present in the aluminum alloy at a weight percent between about 0.7 and 0.9, for example at 0.8.

The aluminum alloy of the present disclosure comprises Cr between 0.05 to 0.35 wt. %. Chromium can retard recrystallization and grain growth of Al alloys by means of Cr containing dispersoid particles. Chromium can be present in the aluminum alloy of the present disclosure in weight percent from about 0.05 to about 0.35, from about 0.05 to about 0.3, from about 0.05 to about 0.25, from about 0.05 to about 0.2, from about 0.05 to about 0.15, from about 0.05 to about 0.1, from about 0.1 to about 0.35, from about 0.15 to about 0.35, from about 0.2 to about 0.35, from about 0.25 to about 0.35, from about 0.3 to about 0.35, from about 0.1 to about 0.3, from about 0.15 to about 0.25. In an embodiment, Cr can be present in the aluminum alloy at a weight percent between about 0.15 to 0.30, for example, at 0.2. In yet another embodiment, Cr can be present in the aluminum alloy at a weight percent of about 0.05.

A grain refiner, such as titanium, titanium boride, or titanium carbide may be optionally included in the aluminum alloys of the present disclosure to solidify aluminum alloys with a fully equiaxed, fine grain structure. In an embodiment, the grain refiner is in the form of Ti, TiB or TiC. When TiB is used as a grain refiner, this may result in a B content of up to 0.05 wt. % in the alloy. When TiC is used as a grain refiner, this may result in a C content of up to 0.01 wt. % in the alloy.

The aluminum alloy of the present disclosure may optionally comprise Ti up to 0.1 wt. %. The dissolved Ti in molten aluminum can enhance the formation of interfacial TiAl₃ layer between TiB₂/melt interface, which subsequently provokes nucleation of Al grains. Ti may be present in the aluminum alloy of the present disclosure in weight percent up to about 0.1, up to about 0.09, up to about 0.08, up to about 0.07, up to about 0.06, up to about 0.05, up to about 0.04, up to about 0.035, up to about 0.03, up to about 0.02, up to about 0.01.

The aluminum alloy of the present disclosure may optionally comprise Si in weight percent between 0.01 and 0.2 wt. %, between 0.05 and 1.5, between 0.05 and 1, between 0.1 and 0.5. Silicon can help improving strength of Al alloys, by precipitation hardening. Si may be present in the aluminum alloy of the present disclosure in weight percent up to about 0.3, up to about 0.2, up to about 0.15, up to about 0.1, up to about 0.05, up to about 0.04, up to about 0.03, up to about 0.02, up to about 0.01.

The aluminum alloy of the present disclosure may optionally comprise Sr up to 0.08 wt %. Sr is useful in modifying the eutectic intermetallic. Sr may be present in the aluminum alloy of the present disclosure in weight percent up to about 0.08, up to about 0.07, up to about 0.06, up to about 0.05, up to about 0.04, up to about 0.03, up to about 0.02, up to about 0.01, up to about 0.005, up to about 0.003, up to about 0.001.

The aluminum alloy of the present disclosure may optionally comprise Zr in weight percent up to about 0.1 wt. %, up to about 0.09, up to about 0.08, up to about 0.07, up to about 0.6, up to about 0.05, up to about 0.03, up to about 0.02 or up to about 0.01. The presence of Zr may improve the mechanical properties of the alloy.

In some embodiments, the balance of the alloy includes aluminum and inevitable impurities. In some embodiments, each of the inevitable impurity is present at a maximum of 0.05 (and in some embodiments 0.03) and the total inevitable impurities comprises less than 0.10.

In some embodiments, Cu may optionally be present in the aluminum alloys of the present disclosure, but only in the form of an inevitable impurity. In the context of the present disclosure, Cu is not a deliberate addition to the aluminum alloys of the present disclosure. When present, the weight percentage of Cu in the aluminum alloys of the present disclosure is less than about 0.05 wt. %, less than about 0.04, less than about 0.03, less than about 0.02 or less than about 0.01.

In some further embodiments, Fe may optionally be present in the aluminum alloy of the present disclosure, but only in the form of an inevitable impurity. The presence of Fe may have a negative impact on the mechanical properties of the alloy. When present, the weight percentage of Fe in the aluminum alloys of the present disclosure is less than about 0.8 wt. %, less than about 0.7, less than about 0.6, less than about 0.5, less than about 0.4, less than about 0.3, less than about 0.2, less than about 0.1, or less than about 0.07.

In still further embodiments, Zn may optionally be present in the aluminum alloy of the present disclosure, but only in the form of an inevitable impurity. The presence of Zn may have a negative impact on the mechanical properties of the alloy. When present, the weight percentage of Zn in the aluminum alloys of the present disclosure is less than about 0.1 wt. %, less than about 0.05, less than about 0.03, less than about 0.02 or less than about 0.01.

The present disclosure also provides a process for making a high strength aluminum product using the aluminum alloy of the present disclosure. In a first step, the process comprises casting the aluminum alloy of the present disclosure to obtain a cast aluminum product. The casting step can include, for example, direct chilled casting, continuous casting and/or semi-continuous casting. A Properzi continuous casting may be used, which may be a wheel and belt casting process or a track & belt casting. The track & belt process replaces the casting wheel by a plurality of copper blocks. Other options include a twin roll caster may be used. The twin roll caster has two rolls that rotate and advance the mold continuously. The rolls may be chilled to aid in solidification of the molten aluminum alloy. Further options include a block caster that has blocks adapted to function as belts. The blocks may be chilled to aid in solidification of the molten aluminum alloy.

In one embodiment, the process comprises casting the aluminum alloy of the present disclosure to obtain a billet, heat treating the billet to obtain a heat treated billet, extruding the heat treated billet to obtain an extruded aluminum rod, submitting the extruded aluminum rod to a cold deformation step to obtain a strip, annealing the strip to obtain a conduit that can be worked into a product. The conduit may be worked to create an armoured cable wrap for example.

In a second step, the cast aluminum product is extruded into an extruded aluminum product. The deformation of the cast aluminum product, such as a rod, can be performed by hot rolling process. Hot rolling may result in a hot rolled rod and/or sheet. During extrusion the aluminum alloy the aluminum alloy is at a temperature when the alloy is malleable. A press container may be used. A hydraulic ram can be used to apply pressure to force the aluminum alloy to fill the container. After the hot deformation (i.e., extrusion or Properzi hot rolling), the aluminum alloy may be actively cooled by the use of cooling fans and/or water spray or a full water quench.

In a third step, the extruded aluminum product is submitted to a deformation step to obtain the rolled aluminum product. The deformation step of the aluminum rod might be cold rolling, hot rolling or both; optionally, the process can include a cold rolling step (which can be performed, for example, after the hot rolling step). Alternatively or in combination, the process can also comprise, after the hot rolling step, annealing the rolled aluminum product to obtain an annealed aluminum product. The hot deformation step can be optimized based on the desired product and the desired microstructure and mechanical properties. In one embodiment, the alloy exhibits a flow stress which is at least 20% less than 5052 and 5154 aluminum alloys during the deformation step.

In one embodiment, the process further comprises after casting and before extruding, heat treating the cast aluminum product, such as a billet. The heat treatment conditions can be at least about 2, at least about 3, at least about 4 or at least about 5 h for a time period between about 450 to about 545° C., about 455 to about 540° C., about 465 to about 540° C., about 475 to about 540° C., about 485 to about 540° C., about 490 to about 535° C., about 495 to about 535° C., about 500 to about 530° C., about 505 to about 525° C., about 510 to about 520° C., about 455 to about 545° C., about 460 to about 540° C., about 465 to about 540° C., about 470 to about 540° C., about 475 to about 540° C., about 480 to about 540° C., about 485 to about 545° C., about 490 to about 545° C., about 495 to about 545° C., about 500 to about 545° C., about 505 to about 545° C., about 510 to about 545° C., about 515 to about 545° C., about 520 to about 545° C., about 525 to about 545° C., about 530 to about 545° C., about 535 to about 545° C., about 450 to about 540° C., about 450 to about 535° C., about 450 to about 530° C., about 450 to about 525° C., about 450 to about 520° C., about 450 to about 515° C., about 450 to about 510° C., about 450 to about 505° C., about 450 to about 500° C., about 450 to about 495° C. or about 450 to about 490° C., about 450 to about 485° C., about 450 to about 480° C.

After the deformation the rolled aluminum product, such as a strip, may further be annealed to improve ductility. Annealing can limit cracking and fatiguing of the product and therefore improve the formability of the product. If necessary annealing may be repeated until the desired product is achieved. Annealing may be performed using a heat treating oven. Annealing can performed for at least about 2, at least about 3, at least about 4, at least about 5, at least about 6, at least about 7 or at least about 8 h for a time period between about 225 to about 375° C., about 230 to about 370° C., about 235 to about 365° C., about 240 to about 365° C., about 245 to about 350° C., about 250 to about 325° C., about 255 to about 320° C., about 260 to about 315° C., about 265 to about 315° C., about 275 to about 310° C., about 280 to about 300° C., about 285 to about 295° C., about 230 to about 375° C., about 235 to about 375° C., about 240 to about 375° C., about 245 to about 375° C., about 250 to about 375° C., about 255 to about 375° C., about 260 to about 375° C., about 265 to about 375° C., about 270 to about 375° C., about 275 to about 375° C., about 280 to about 375° C., about 285 to about 375° C., about 290 to about 375° C., about 295 to about 375° C., about 300 to about 375° C., about 305 to about 375° C., about 310 to about 375° C., about 315 to about 375° C., about 225 to about 370° C., about 225 to about 360° C., about 2225 to about 350° C., about 225 to about 340° C., about 225 to about 305° C., about 225 to about 300° C., about 225 to about 295° C., about 225 to about 290° C., about 225 to about 290° C., about 225 to about 285° C., about 225 to about 280° C., about 225 to about 275° C., about 225 to about 270° C., about 225 to about 265° C. or about 225 to about 260° C.

In one embodiment, the extruded/rolled product (rod) has an Ultimate Tensile Strength (UTS) of at least 150, at least 155, at least 160, at least 165, at least 170 or at least 175 MPa. In one embodiment, the extruded/rolled product has a yield of at least 40, at least 45, at least 50, at least 55, at least 60, at least 65 or at least 70 MPa. In one embodiment, the extruded product has an elongation (E %) of at least 15%, at least 16%, at least 17%, at least 18%, at least 19 or at least 20%.

In one embodiment, the rolled aluminum product (strip) has a UTS of at least 290, at least 295, at least 300, at least 305 or at least 310 MPa. In one embodiment, the rolled aluminum product (strip) has an elongation (E %) of at least 0.4%, at least 0.5%, at least 0.6%, at least 0.7%, at least 0.8% or at least 0.9%.

In one embodiment, the annealed aluminum product (strip) has a UTS of at least 235, at least 240, at least 245, at least 250, at least 255, at least 260 or at least 265. In embodiment, the annealed aluminum product has an elongation (E %) of at least 4%, at least 4.1% at least 4.2%, at least 4.3%, at least 4.4%, at least 4.5%, at least 4.6%, at least 4.7%, at least 4.8%, at least 4.9%, at least 5%, at least 5.1%, at least 5.2%, at least 5.3% at least 5.4%, at least 5.5% or at least 5.6%.

### Example I: Initial Screening of Alloy Compositions

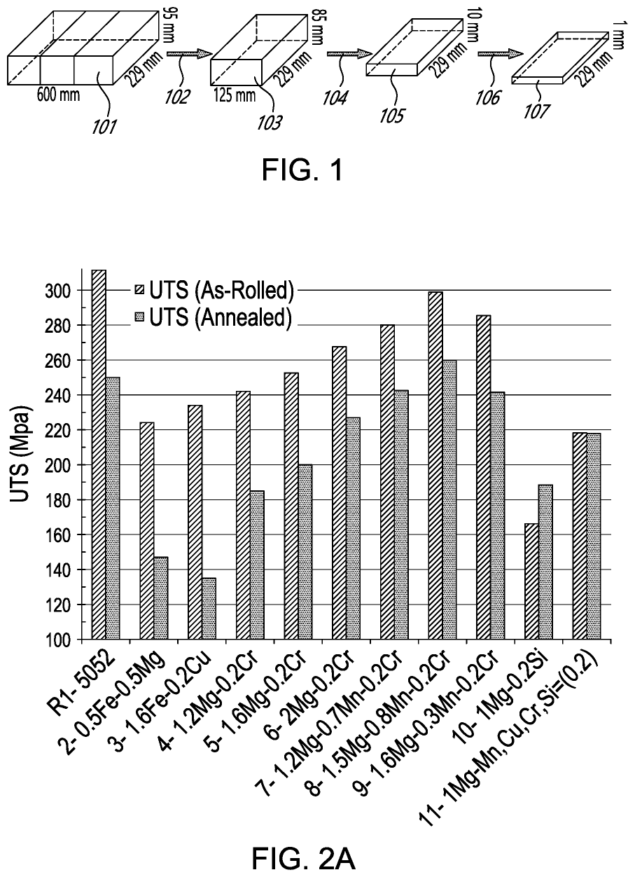

A direct chilled (DC)-cast ingot (101), as shown in FIG. 1, with a length of 229 mm, a width of 600 mm and a height of 95 mm was cut and scalped (at step 102) into an as-cast rolling blocks (103). The rolling blocks (103) had the following dimensions: 229 mm length, 125 mm width, and 85 mm height. The rolling blocks (103) were then preheated (at step 104) for at least 5 hours, between 450-545° C., to form preheated blocks (105). The preheated blocks (105) were consequently hot-rolled (at step 104) to reach about 10 mm thickness. During the hot rolling process the block temperatures were always kept above 400° C. The hot-rolled blocks (105) were then cold rolled down (at step 106) to a thickness of 1 mm to form cold-rolled blocks (107). The tensile mechanical properties of various aluminum products described in FIG. 1 obtained as described were measured using the ASTM B233 and B557 standards.

Eleven different chemical compositions were selected, and were cast by means of the procedure described and shown in FIG. 1. The cast blocks of each alloy were initially preheated, hot rolled, and subsequently cold rolled to make strips with about 1 mm thickness. The elemental composition of the different alloys used are summarized in Table 1. The selected alloys included also 5052 alloy as the reference sample, which was cast to compare the mechanical properties of the selected alloys with the a commonly used cable wrap alloy (5052).

An alloy having a composition close to the 5052 alloy but with a lower Mg content in which the Mg content was gradually increased could not be cast. The applied torque was increased with the increasing Mg content to the point where, after a few minutes and at a concentration of about 2.0 wt. % Mg, the torque surpassed the maximum recommended torque of the Properzi machine. The test was therefore stopped in order to avoid damage to the Properzi machine.

TABLE 1
Elemental composition of the different aluminum alloys used in this example

| | Alloy Code | Si (%) | Fe (%) | Cu (%) | Mn (%) | Mg (%) | Cr (%) | Ti (%) |
|---|---|---|---|---|---|---|---|---|
| 1 | 5052 | 0.037 | 0.158 | 0.003 | 0.009 | 2.45 | 0.216 | 0.026 |
| 2 | 0.5Fe—0.5Mg | 0.034 | 0.492 | 0.004 | 0.009 | 0.49 | 0.001 | 0.029 |
| 3 | 1.6Fe—0.2Cu | 0.035 | 1.675 | 0.2092 | 0.0011 | 0.0007 | 0.001 | 0.029 |
| 4 | 1.2Mg—0.2Cr | 0.04 | 0.14 | 0.002 | 0.013 | 1.19 | 0.19 | 0.024 |
| 5 | 1.6Mg—0.2Cr | 0.04 | 0.15 | 0.002 | 0.013 | 1.59 | 0.2 | 0.025 |
| 6 | 2Mg—0.2Cr | 0.04 | 0.15 | 0.002 | 0.013 | 1.98 | 0.21 | 0.024 |
| 7 | 1.2Mg—0.7Mn—0.2Cr | 0.04 | 0.14 | 0.2 | 0.7 | 1.19 | 0.2 | 0.026 |
| 8 | 1.5Mg—0.8Mn—0.2Cr | 0.05 | 0.15 | 0.003 | 0.8 | 1.5 | 0.2 | 0.025 |
| 9 | 1.6Mg—0.3Mn—0.2Cr | 0.05 | 0.14 | 0.2 | 0.29 | 1.58 | 0.2 | 0.023 |
| 10 | 1Mg—0.2Si | 0.2 | 0.13 | 0.003 | 0.001 | 0.98 | 0.001 | 0.028 |
| 11 | 1Mg—Mn, Cu, | 0.15 | 0.15 | 0.2 | 0.2 | 1.01 | 0.19 | 0.024 |
| | Cr, Si═(0.2) | | | | | | | |

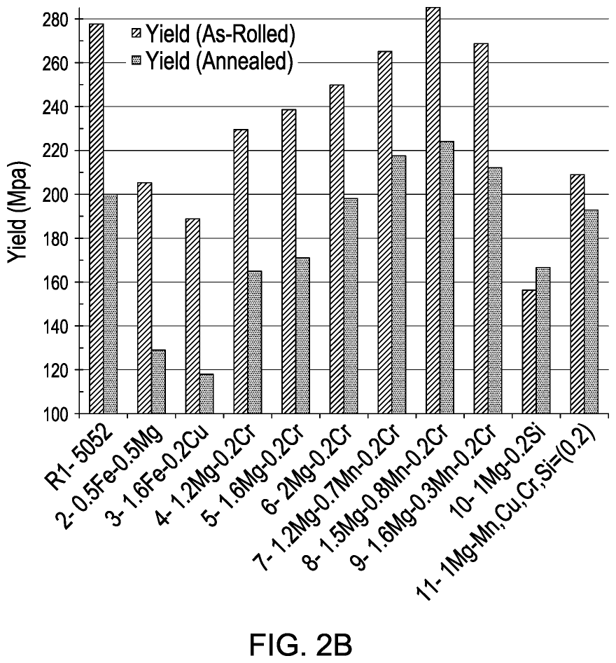

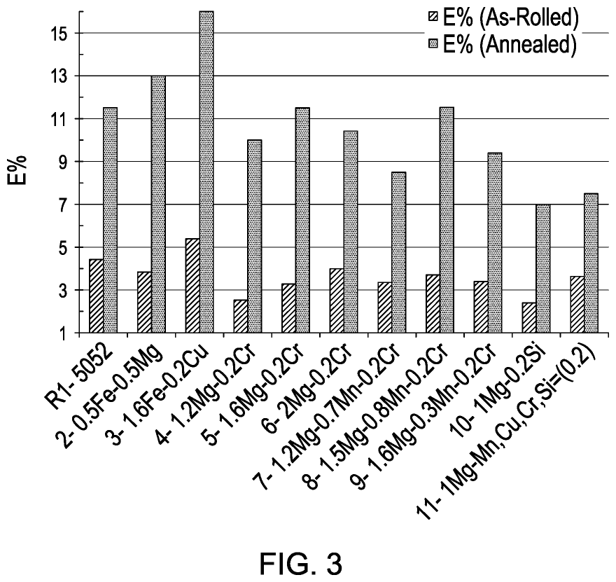

The ultimate tensile strength (UTS) of the as rolled strips obtained by the method explained in FIG. 1 are shown in FIG. 2 by diagonal hatched bars. The strips of alloys #7, #8 and #9 presented a comparable yield and UTS with the reference alloy (alloy #1, 5052). The elongations of the as rolled products are illustrated in FIG. 3 by the diagonal hatched bars. Aluminum products obtained from alloys #7, #8 and #9 have a comparable elongation (E %) with the reference alloy (alloy #1). As the elongations for most of the targeted alloys (even including the reference alloy, 5052) were fairly low (less than 5%), therefore the strips were annealed for at least 2 hours in between 225-375° C. The UTS and yield of the annealed strips are presented in FIGS. 2A and 2B by the solid bars, respectively. As shown, the three alloys #7, #8 and #9 preserved fairly well their tensile strength after the annealing treatment, and the strength results are still as high as the reference alloy (5052). The elongation percent (E %) of the annealed strips are shown in FIG. 3 by the solid bars. The annealing treatment improved the elongation of all the studied alloys in a significant manner.

### Example II: Fabrication and Characterization of Armoured Cable Wrap

As indicated in Example I, the three alloys (#7, #8 & #9, out of the ten targeted chemistries), presented tensile mechanical properties comparable to the reference alloy (#1 or 5052).

Subsequently, in the next step, three other alloys with chemistries close to the successful three candidates, plus 5052 (as reference alloy) were produced by the industrial fabrication process. The industrial production process is usually composed of Properzi rod mill caster continued with cold deformation to make a strip and subsequently to make a conduit. The elemental composition of the new targeted alloys for further studies are summarized in Table 2.

TABLE 2
Alloy compositions of the aluminum products for their mechanical properties (the
base alloy comprising 0.15 Fe and the balance being Al and inevitable impurity)

| | Alloy Code | Si (%) | Fe (%) | Cu (%) | Mn (%) | Mg (%) | Cr (%) | Ti (%) |
|---|---|---|---|---|---|---|---|---|
| 12 | 5052 | 0.04 | 0.14 | 0.003 | 0.01 | 2.47 | 0.2 | 0.021 |
| 13 | 1.7Mg0.3Mn | 0.04 | 0.15 | 0.003 | 0.3 | 1.7 | 0.2 | 0.025 |
| 14 | 1.5Mg0.3Mn0.3Cu | 0.04 | 0.15 | 0.28 | 0.29 | 1.48 | 0.19 | 0.026 |
| 15 | 1.5Mg0.8Mn | 0.05 | 0.14 | 0.004 | 0.81 | 1.53 | 0.19 | 0.023 |

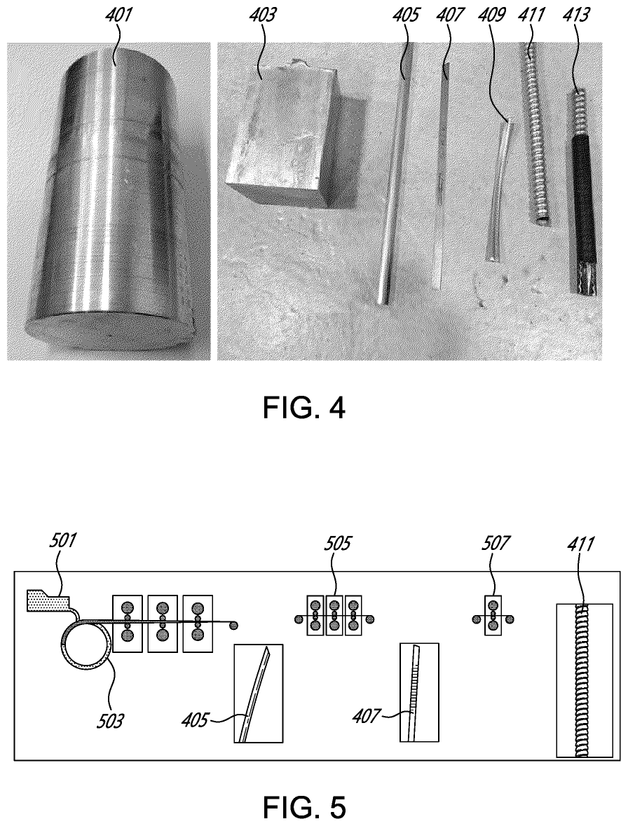

As shown in FIGS. 4 and 5, in an industrial Properzi machine, a cast bar with trapezoidal shape (403) is obtained from a billet (401). The cast bar has a bottom width of 88 mm, a top width of 97.45 mm and a height of 58 mm and is initially cast (501) by the Properzi wheel caster, and then it is hot rolled (503) down to a 9.5 mm rod (405). The Properzi process steps was simulated in laboratory, by means of DC-casting of billet (with 101 mm diameter) (Properzi wheel caster), solution treating of the billets for at least 5 hours at 450-545° C., and extruding them with a rod mill to 9.5 mm diameter rod. Metallography analysis and tensile strength test confirmed that the aluminum alloy produced by this procedure presented similar microstructure, and mechanical properties as the materials produced by means of the Properzi machine.

Following the extrusion process, the 9.5 mm diameter rods (405) were cold rolled (505) down to strips (407) format of 9.5 mm width and about 1 mm thickness. Then, the strips (407) were annealed for at least two hours at about 225 to 375° C., to finally being transformed into conduit (409). The conduit (409) were then be made (507) into an armour (411) and an armoured cable wrap (413).

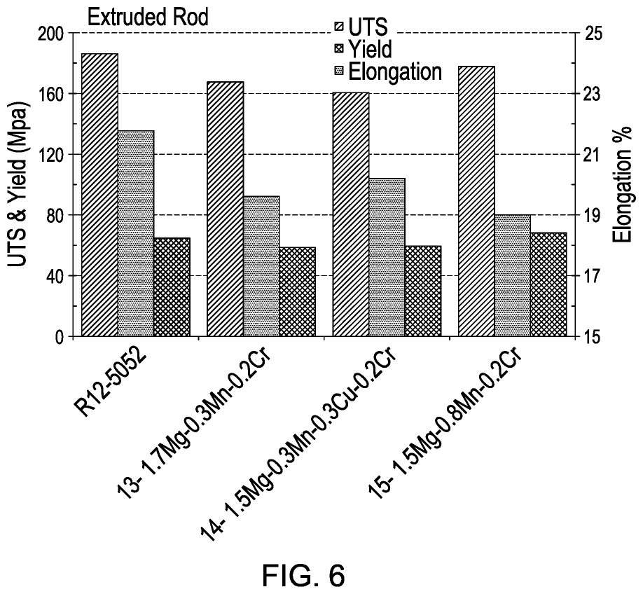

The tensile mechanical properties of various aluminum products obtained as described in Example I were measured using the ASTM B233 and B557 standards. FIG. 6 illustrates the tensile strength properties for four different extruded rods (9.5 mm diameter) made of the aluminum alloys described in Table 2. As can be observed in FIG. 6, rods made from alloy #15 have a better UTS than rods made from alloy #13 and #14 and presented comparable UTS to the rods made of alloy #12 (as the reference alloy). In addition, rods made of alloy #15 presented comparable yield and E % to the rods made of alloys #13 or #14.

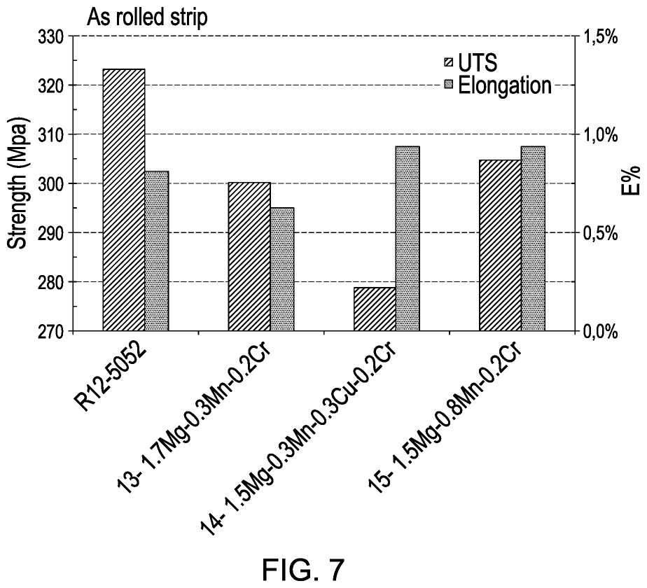

As can be observed in FIG. 7, the rolled strips made of alloy #15 have a better UTS than the rolled strips made of alloys #13 and #14 and a comparable elongation. However, the UTS of rolled strips made of alloy #15 is slightly lower than the UTS of rolled strips made of alloy #12 (the reference alloy, 5052).

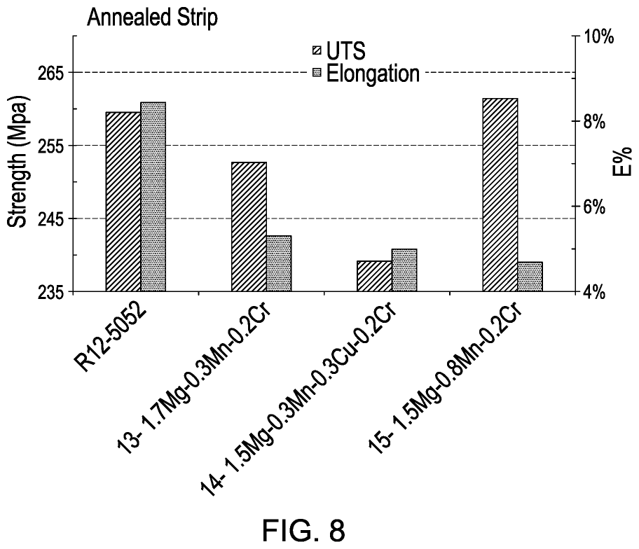

FIG. 8 provides the results of four different rolled strips submitted to an annealing heat treatment fort at least two hours at about 225 to 375° C. The heat treated strips made from alloy #15 presented much higher UTS compared to alloys #13 and #14, but with similar E %. The UTS of the alloy #15 was slightly better than the reference alloy (#12, 5052), but it presented lower E %.

A pull test (UL 4 Ed. 15 Standard for Armored Cable) was performed on the conduit obtained from the different alloys tested. The results of the pull test are shown in Table 3. The minimum requirement pull test for the conduit is 136 kg (300 pounds). The conduits made of alloy #15 (and the reference alloy #12, 5052) successfully passed the pull test while the other two alloys were failed with much lower pull strength. Even though the E % of alloy #15 was lower than alloy the reference alloy (#12), but it was formable enough and presented high strength which successfully passed the specification requirement.

TABLE 3
Results of the pull test for different alloy
compositions

| | | Passed Pull Test |
|---|---|---|
| | Alloy Code | (136 kg Min) |
| 12 | 5052 | Yes |
| 13 | 1.7 Mg-0.3 Mn-0.2 Cr | Fail, 285 lb.s |
| 14 | 1.5 Mg-0.3 Mn-0.3 Cu-0.2 Cr | Fail, 275 lb.s |
| 15 | 1.5 Mg-0.8 Mn-0.2 Cr | Yes |

### Example III: Fabrication and Characterization of Armoured Cable Wrap

Armored cable wraps were made according to the process described in Example I and the process shown in FIG. 5. The aluminum alloy elemental composition used to make the armoured cable wrap is presented in Table 4.

TABLE 4
Alloy elemental compositions of the aluminum
products tested (the base alloy
comprising 0.15 Fe and the balance being
Al and inevitable impurity)

| Alloy code | 16 | 17 | 18 | 19 | R12 |
|---|---|---|---|---|---|
| Composition | 4.5 Si | 0.5 Si | 2 Si, | 0.3 Fe | 2.4 Mg- |
| in wt. % | 0.15 Mg | 0.6 Mg, | 0.3 Mg | 0.15 Cu | 0.2 Cr |
| | | | | | (5052 or |
| | | | | | control) |

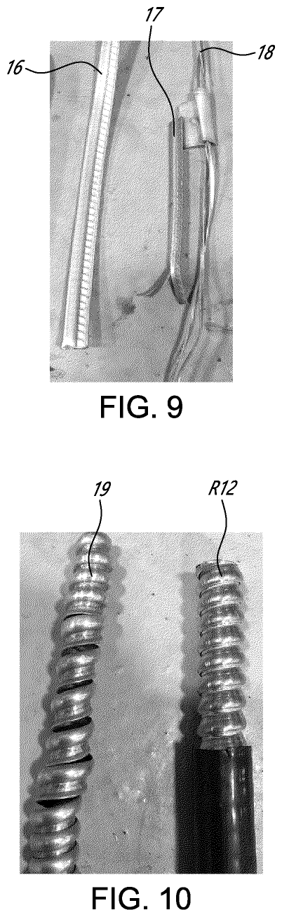

It was not possible to make an armoured cable wrap from alloys #16, #17 and #18 (FIG. 9). Aluminum products made from alloys #16, #17 and #18 did not provide enough formability, and were failed at the step of the strip to conduit conversion. The resulting strip #12 from the commercially available 5052 composition is shown in FIG. 9 as positive control.

It was not possible to make an armoured cable wrap with alloy #19 (FIG. 10). Aluminum products made from alloy #19 did not provided enough strength to pass the pull test requirement, and it was failed by a 56.7 kg (125 lbs) pull test. Furthermore, after making the cable wrap, as the strength was not enough, it did not tolerate the min required force. The conduit obtained from alloy 19 is compared to an exemplary armoured cable wrap (made from alloy #12) in FIG. 10.

As can be seen therefore, the examples described above and illustrated are intended to be exemplary only. The scope is indicated by the appended claims.

1. An aluminum alloy comprising, in weight percent:
1.0-2.0 Mg;
0.2-0.95 Mn;
0.05-0.35 Cr;
0.00-0.1 Ti;
0.00-0.08 Sr; and
the balance being aluminum and inevitable impurities, and wherein the inevitable impurities comprise 0.00-0.05 wt. % Cu.

2. The aluminum alloy according to claim 1, comprising up to 0.05 wt. % Ti.

3. The aluminum alloy according to claim 1, comprising 1.2-1.9 wt. % Mg.

4. The aluminum alloy according to claim 1, comprising 0.4-0.9 wt. % Mn.

5. The aluminum alloy according to claim 1, comprising 0.05-0.3 wt. % Cr.

6. The aluminum alloy according to claim 1, comprising 0.01-0.2 wt. % Si.

7. The aluminum alloy according to claim 1, comprising up to 0.05 wt. % Sr.

8. The aluminum alloy according to claim 1, wherein the inevitable impurities comprise less than 0.1 wt. % of the aluminum alloy and each inevitable impurity is present at a maximum of 0.05 wt. %.

9. A process of making a rolled aluminum product, the process comprising:
(a) casting the aluminum alloy of claim 1 to obtain a cast aluminum product;
(b) extruding the cast aluminum to obtain an extruded aluminum product; and
(c) submitting the extruded product to a hot deformation step to obtain the rolled aluminum product.

10. The process of claim 9, wherein step (a) comprises direct chilled casting, continuous casting or semi-continuous casting.

11. The process of claim 9, wherein the cast aluminum product is a billet.

12. The process of claim 9, further comprising, after step (a) and before step (b), heat treating the cast aluminum product.

13. The process of claim 12, wherein heat treating the billet comprises a heat treatment for at least 2 h at about 450 to about 545° C. to form a heat treated billet.

14. The process of claim 13, comprising extruding the heat treated billet into the extruded aluminum product, wherein the extruded aluminum product is an extruded rod.

15. The process of claim 14, wherein step (c) comprises hot rolling the extruded rod down to obtain the rolled aluminum product.

16. (canceled)

17. The process of claim 9, further comprising
(d) annealing the rolled aluminum product.

18. The process of claim 17, wherein step (d) comprises annealing the rolled aluminum product for at least 2 hours at about 225 to about 375° C. to obtain an annealed aluminum product.

19. The process of claim 18, wherein the annealed aluminum product is an annealed aluminum strip.

20. The process of claim 19 further comprising working the annealed aluminum strip to obtain a conduit of an armoured cable wrap.

21. The process of claim 9, wherein the rolled aluminum is configured for making an automotive body, a trailer panel, a hollow electrical conduit, a building product or a construction product.

22-24. (canceled)
